(19) United States
(12) Patent Application Publication
(10) Pub. No.: US 2026/0171097 A1
(43) Pub. Date: Jun. 18, 2026

(54) RELEVANCY-BASED EXPLAINABLE AI FOR AUDIO DEEPFAKE DETECTION

(71) Applicant: Reality Defender, Inc., New York, NY (US)

(72) Inventors: Gaurav BHARAJ, Los Angeles, CA (US); Petr GRINBERG, Lausanne (CH); Ankur KUMAR, Los Angeles, CA (US); Surya KOPPISETTI, Coquitlam (CA)

(73) Assignee: Reality Defender, Inc., New York, NY (US)

(21) Appl. No.: 19/420,451

(22) Filed: Dec. 15, 2025

Related U.S. Application Data
(60) Provisional application No. 63/735,210, filed on Dec. 17, 2024.

(51) Int. Cl. G10L 17/26; G10L 17/04

(52) U.S. Cl. CPC G10L 17/26; G10L 17/04

(57) ABSTRACT

An exemplary method for determining a contribution of different portions of an audio signal to a deepfake detection machine learning model output includes inputting a plurality of tokens into a deepfake detection machine learning model trained to predict whether the audio signal comprises synthetically generated audio; generating, using the deepfake detection machine learning model, a plurality of output tokens; generating, using the deepfake detection machine learning model, a classification output indicating whether the audio signal comprises synthetically generated audio based on the plurality of output tokens; determining a plurality of relevancy metrics associated with the plurality of output tokens for each portion of the audio signal; determining a weighting for each of the plurality of relevancy metrics; and determining a contribution of each of the plurality of portions of the audio signal to the classification output based on a weighted relevancy of each portion.

### CROSS REFERENCE TO RELATED APPLICATIONS

This application claims the benefit of U.S. Provisional Application No. 63/735,210, filed Dec. 17, 2024, the entire contents of which is incorporated herein by reference.

### FIELD

This disclosure relates generally to deepfake detection and more specifically to deepfake detection methods with improved explainability.

### BACKGROUND

Recent audio deepfake detection (ADD) models are based on pre-trained self-supervised models, such as Wav2Vec2, which serve as black-box feature extractors that achieve strong performance on the downstream task (e.g., classification). Such ADD models, particularly transformer based ADD models, often lack robust explainability. While some forms of explainable AI for ADD have been developed, limited work exists on the interpretation of self-supervised models at waveform level in the time domain. Moreover, despite the state-of-the-art ADD models being predominantly based on the transformer architecture, little work has been done on transformer explainable AI for ADD models.

### SUMMARY

Disclosed herein are systems, devices, methods, and non-transitory computer-readable storage media for detecting deepfake audio using deepfake detection machine learning models. The techniques disclosed herein provide indications of the contribution of different portions of the audio to the output of the deepfake detection machine learning models, thus providing provide robust explainability for audio deepfake detection (ADD) models. The techniques disclosed herein provide enhanced explainability for AI models, including self-supervised transformer-based audio deepfake detection models. The systems, methods, and devices disclosed herein may implement a relevancy-based explainable AI (XAI) method for analyzing the predictions of transformer-based ADD models.

An exemplary system may extract a plurality of tokens corresponding to a plurality of audio features from an audio signal. A plurality of tokens may be extracted from each of a plurality of portions of the audio signal. The system may input the plurality of tokens into a deepfake detection machine learning model trained to predict whether the audio signal comprises synthetically generated audio (as used herein, synthetically generated audio may refer to audio generated using a machine learning model). The deepfake detection machine learning model may generate a plurality of output tokens. One or more of the plurality of output tokens may include an indication of whether the audio signal comprises synthetically generated audio. The system may determine a plurality of relevancy metrics (e.g., a relevancy map) associated with the plurality of output tokens. The relevancy metrics may be determined for the plurality of output tokens associated with each portion of the audio signal. The system may determine a weighting for each of the plurality of relevancy metrics. The weighting may be determined using an attention map generated using the deepfake detection machine learning model. The system may determine a contribution of each of the plurality of portions of the audio signal to the classification output based on a weighted relevancy of each portion. The system may provide an indication of the contribution, for instance, by generating a visualization such as a heatmap on a graphical user interface.

In some examples, the system may utilize the determined contribution of different portions of an audio signal to an output of a deepfake detection machine learning model to create new training data and train (or retrain, finetune, etc.) the deepfake detection machine learning model. An exemplary system may mask one or more portions of the audio signal based on the determined contribution of the of the plurality of portions of the audio signal to the classification output to create masked training data. The system may input the masked training data into the deepfake detection machine learning model to train the deepfake detection machine learning model based on the masked audio signal. Masking the one or more portions of the audio signal may include masking one or more portions determined to contribute by an above-threshold amount to the classification output. Training the audio deepfake detection using masked training data wherein one or more portions determined to contribute by an above-threshold amount to the classification output of the audio deepfake detection machine learning model may enable the model to learn different features associated with synthetically generated audio, resulting in a more robust audio deepfake detection machine learning model. In some examples, masking the one or more portions of the audio signal comprises masking one or more portions determined to contribute by a below-threshold amount to the classification output. Masking those portions that contributed relatively less to the audio deepfake detection model output may further finetune a model for detecting certain characteristics of synthetically generated audio.

According to an aspect, an exemplary method for determining a contribution of different portions of an audio signal to a deepfake detection machine learning model output comprises: receiving an audio signal; extracting a plurality of tokens corresponding to a plurality of features of the audio signal from each of a plurality of portions of the audio signal; inputting the plurality of tokens into the deepfake detection machine learning model trained to predict whether the audio signal comprises synthetically generated audio; generating, using the deepfake detection machine learning model, a plurality of output tokens, wherein each of the plurality of output tokens comprises an indication of whether the audio signal comprises synthetically generated audio; generating, using the deepfake detection machine learning model, a classification output indicating whether the audio signal comprises synthetically generated audio based on the plurality of output tokens; determining a plurality of relevancy metrics associated with the plurality of output tokens for each portion of the audio signal; determining a weighting for each of the plurality of relevancy metrics; determining a contribution of each of the plurality of portions of the audio signal to the classification output based on a weighted relevancy of each portion; and indicating the contribution of each of the plurality of portions of the audio signal to the classification output.

Optionally, the method includes masking one or more portions of the audio signal based on the determined contribution of the of the plurality of portions of the audio signal to the classification output; and training the deepfake detection machine learning model based on the masked audio signal.

Optionally, masking the one or more portions of the audio signal comprises masking one or more portions determined to contribute by an above-threshold amount to the classification output.

Optionally, masking the one or more portions of the audio signal comprises masking one or more portions determined to contribute by a below-threshold amount to the classification output.

Optionally, masking the one or more portions of the audio signal comprises replacing the one or more portions with noise.

Optionally, the weighting for each of the plurality of relevancy metrics is determined based on an attention map associated with the plurality of output tokens.

Optionally, the method includes comparing the determined contribution of the plurality of portions of the audio file to ground-truth labels associated with the audio file, wherein the ground truth labels indicate whether the plurality of portions of the audio file comprise synthetically generated audio; determining that a model performance threshold is not satisfied based on the comparison; and updating the deepfake detection machine learning model.

Optionally, indicating the contribution of each of the plurality of portions of the audio signal to the classification output includes generating a visualization of the contribution of each of the plurality of portions of the audio signal to the classification output comprises generating a visualization of the contribution of each of the plurality of portions of the audio signal to the classification output.

Optionally, the visualization comprises a heatmap.

Optionally, the weighted relevancy of each portion of the audio signal comprises a vector representation of a relevancy of each portion of the audio signal.

Optionally, each of the plurality of portions of the audio signal forms a timestep of a waveform.

Optionally, one or more of the plurality of input tokens correspond to speech data.

Optionally, one or more of the plurality of input tokens correspond to non-speech data.

Optionally, the deepfake detection machine learning model comprises a transformer model

According to an aspect, system for determining a contribution of different portions of an audio signal to a deepfake detection machine learning model output, the system comprising one or more processors, a memory, and one or more programs, wherein the one or more programs are stored in the memory and configured to be executed by the one or more processors, the one or more programs including instructions for: receiving an audio signal; extracting a plurality of tokens corresponding to a plurality of features of the audio signal from each of a plurality of portions of the audio signal; inputting the plurality of tokens into the deepfake detection machine learning model trained to predict whether the audio signal comprises synthetically generated audio; generating, using the deepfake detection machine learning model, a plurality of output tokens, wherein each of the plurality of output tokens comprises an indication of whether the audio signal comprises synthetically generated audio; generating, using the deepfake detection machine learning model, a classification output indicating whether the audio signal comprises synthetically generated audio based on the plurality of output tokens; determining a plurality of relevancy metrics associated with the plurality of output tokens for each portion of the audio signal; determining a weighting for each of the plurality of relevancy metrics; determining a contribution of each of the plurality of portions of the audio signal to the classification output based on a weighted relevancy of each portion; and indicating the contribution of each of the plurality of portions of the audio signal to the classification output.

According to an aspect, an exemplary non-transitory computer-readable storage medium storing one or more programs for determining a contribution of different portions of an audio signal to a deepfake detection machine learning model output, the one or more programs comprising instructions, which when executed by one or more processors of an electronic device, cause the electronic device to: receive an audio signal; extract a plurality of tokens corresponding to a plurality of features of the audio signal from each of a plurality of portions of the audio signal; input the plurality of tokens into the deepfake detection machine learning model trained to predict whether the audio signal comprises synthetically generated audio; generate, using the deepfake detection machine learning model, a plurality of output tokens, wherein each of the plurality of output tokens comprises an indication of whether the audio signal comprises synthetically generated audio; generate, using the deepfake detection machine learning model, a classification output indicating whether the audio signal comprises synthetically generated audio based on the plurality of output tokens; determine a plurality of relevancy metrics associated with the plurality of output tokens for each portion of the audio signal; determine a weighting for each of the plurality of relevancy metrics; determine a contribution of each of the plurality of portions of the audio signal to the classification output based on a weighted relevancy of each portion; and indicate the contribution of each of the plurality of portions of the audio signal to the classification output.

According to an aspect, a method for training a deepfake detection machine learning model comprises: inputting an audio signal into the deepfake detection machine learning model; in a first training stage, training the deepfake detection machine learning model using the audio signal to generate an output indicating whether the audio signal comprises synthetically generated audio; determining a contribution of a plurality of portions of the audio signal to the output of the deepfake detection machine learning model, comprising determining a weighted relevancy of a plurality of output tokens of the deepfake detection machine learning model; identifying one or more portions of the plurality of portions of the audio signal that contributed by an above threshold amount to the output of the deepfake detection machine learning model; masking the one or more portions of the plurality of portions of the audio signal to generate a masked audio signal; and in a second training stage, training the machine learning model using the masked audio signal.

Optionally, wherein inputting the audio signal into the deepfake detection machine learning model comprises: extracting a plurality of tokens corresponding to a plurality of features of the audio signal from each of the plurality of portions of the audio signal; and inputting the plurality of tokens into the deepfake detection machine learning model trained to predict whether the audio signal comprises synthetically generated audio.

Optionally, the deepfake detection machine learning model is trained to: generate a plurality of output tokens, wherein each of the plurality of output tokens comprises an indication of whether the audio signal comprises synthetically generated audio; and generate a classification output indicating whether the audio signal comprises synthetically generated audio based on the plurality of output tokens.

Optionally, determining the contribution of the plurality of portions of the audio signal to the output of the deepfake detection machine learning model based on the weighted relevancy of a plurality of output tokens corresponding to the plurality of portions of the audio signal comprises: determining a plurality of relevancy scores associated with the plurality of output tokens for each portion of the audio signal; determining a weighting for each of the plurality of relevancy scores based on an attention map associated with the plurality of output tokens; and determining a contribution of each of the plurality of portions of the audio signal to the classification output based on a weighted relevancy of each portion.

According to an aspect, an exemplary system for training a deepfake detection machine learning model comprises one or more processors, a memory, and one or more programs, wherein the one or more programs are stored in the memory and configured to be executed by the one or more processors, the one or more programs including instructions for; inputting an audio signal into the deepfake detection machine learning model; in a first training stage, training the deepfake detection machine learning model using the audio signal to generate an output indicating whether the audio signal comprises synthetically generated audio; determining a contribution of a plurality of portions of the audio signal to the output of the deepfake detection machine learning model, comprising determining a weighted relevancy of a plurality of output tokens of the deepfake detection machine learning model; identifying one or more portions of the plurality of portions of the audio signal that contributed by an above threshold amount to the output of the deepfake detection machine learning model; masking the one or more portions of the plurality of portions of the audio signal to generate a masked audio signal; and in a second training stage, training the machine learning model using the masked audio signal.

According to an aspect, an exemplary non-transitory computer-readable storage medium stores one or more programs for training a deepfake detection machine learning model, the one or more programs comprising instructions, which when executed by one or more processors of an electronic device, cause the electronic device to: input an audio signal into the deepfake detection machine learning model; in a first training stage, train the deepfake detection machine learning model using the audio signal to generate an output indicating whether the audio signal comprises synthetically generated audio; determine a contribution of a plurality of portions of the audio signal to the output of the deepfake detection machine learning model, comprising determining a weighted relevancy of a plurality of output tokens of the deepfake detection machine learning model; identify one or more portions of the plurality of portions of the audio signal that contributed by an above threshold amount to the output of the deepfake detection machine learning model; mask the one or more portions of the plurality of portions of the audio signal to generate a masked audio signal; and in a second training stage, train the machine learning model using the masked audio signal.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary method for detecting deepfake audio and indicating a contribution of different portions of the audio to the output, according to some examples.

FIG. 2 illustrates an exemplary method for training a deepfake detection machine learning model, according to some examples.

FIG. 3 illustrates an exemplary computing device, according to some examples.

FIG. 4 illustrates a comparison of explainable AI methods according to some examples.

FIG. 5 illustrates another comparison of explainable AI methods indicating whether the ADD model focuses on speech or non-speech according to some examples.

FIG. 6 illustrates another comparison of explainable AI methods indicating performance metrics associated with the various methods according to some examples.

FIG. 7 illustrates normalized relative contribution quantification (RCQs) for different categories, Relevance Mass Accuracy (RMA), and Relative Rank Accuracy (RRA) for different explainable AI methods on the PartialSpoof dataset according to some examples.

FIG. 8 illustrates normalized RCQ scores for different categories calculated on Gradient Average Transformer Relevancy (GATR) heatmaps according to some examples.

FIG. 9 illustrates normalized RCQ scores for different categories calculated on Gradient Average Transformer Relevancy (GATR) heatmaps according to some examples.

### DETAILED DESCRIPTION

Disclosed herein are systems, devices, methods, and non-transitory computer-readable storage media for detecting deepfake audio using deepfake detection machine learning models. The techniques disclosed herein provide indications of the contribution of different portions of the audio to the output of the deepfake detection machine learning models, thus providing provide robust explainability for audio deepfake detection (ADD) models. The techniques disclosed herein provide enhanced explainability for AI models, including self-supervised transformer-based audio deepfake detection models. The systems, methods, and devices disclosed herein may implement a relevancy-based explainable AI (XAI) method for analyzing the predictions of transformer-based ADD models.

An exemplary system may extract a plurality of tokens corresponding to a plurality of audio features from an audio signal. A plurality of tokens may be extracted from each of a plurality of portions of the audio signal. The system may input the plurality of tokens into a deepfake detection machine learning model trained to predict whether the audio signal comprises synthetically generated audio (as used herein, synthetically generated audio may refer to audio generated using a machine learning model). The deepfake detection machine learning model may generate a plurality of output tokens. One or more of the plurality of output tokens may include an indication of whether the audio signal comprises synthetically generated audio. The system may determine a plurality of relevancy metrics (e.g., a relevancy map) associated with the plurality of output tokens. The relevancy tokens may be determined for the plurality of output tokens associated with each portion of the audio signal. The system may determine a weighting for each of the plurality of relevancy metrics. The weighting may be determined using an attention map generated using the deepfake detection machine learning model. The system may determine a contribution of each of the plurality of portions of the audio signal to the classification output based on a weighted relevancy of each portion. The system may provide an indication of the contribution, for instance, by generating a visualization such as a heatmap on a graphical user interface.

In some examples, the system may utilize the determined contribution of different portions of an audio signal to an output of a deepfake detection machine learning model to create new training data and train (or retrain, finetune, etc.) the deepfake detection machine learning model. An exemplary system may mask one or more portions of the audio signal based on the determined contribution of the of the plurality of portions of the audio signal to the classification output to create masked training data. The system may input the masked training data into the deepfake detection machine learning model to train the deepfake detection machine learning model based on the masked audio signal. Masking the one or more portions of the audio signal may include masking one or more portions determined to contribute by an above-threshold amount to the classification output. Training the audio deepfake detection using masked training data wherein one or more portions determined to contribute by an above-threshold amount to the classification output of the audio deepfake detection machine learning model may enable the model to learn different features associated with synthetically generated audio, resulting in a more robust audio deepfake detection machine learning model. In some examples, masking the one or more portions of the audio signal comprises masking one or more portions determined to contribute by a below-threshold amount to the classification output. Masking those portions that contributed relatively less to the audio deepfake detection model output may further finetune a model for detecting certain characteristics of synthetically generated audio.

In some examples, one or more machine learning models may be trained to generate media data, including audio data. The one or more machine learning models may be trained to reduce, including minimize, aspects of the generated media data determined to contribute relatively more to an audio deepfake detection machine learning model, according to the methods disclosed herein. By identifying which portions of an audio signal contribute most to a deepfake detection model's output, a generative machine learning model can be trained to generate synthetic media data that is more difficult to detect. The generated data can, in turn, be used to train, retrain, and finetune the audio deepfake detection machine learning models disclosed herein, thus iteratively improving the detection capabilities of the audio deepfake detection machine models.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

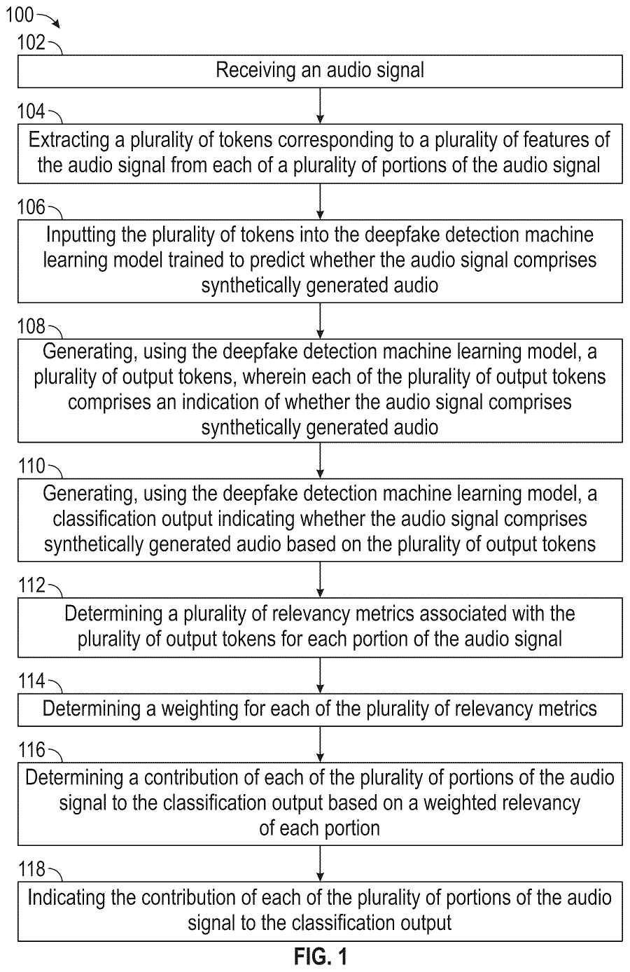

FIG. 1 illustrates aspects of an exemplary process 100 for detecting deepfake audio and indicating a contribution of different portions of the audio to the output. Process 100 is performed, for example, using one or more electronic devices implementing a software platform. In some examples, process 100 is performed using a client-server system, and the blocks of process 100 are divided up in any manner between the server and a client device. In other examples, the blocks of process 100 are divided up between the server and multiple client devices. Thus, while portions of process 100 may be described herein as being performed by particular devices of a client-server system, it will be appreciated that process 100 is not so limited. In other examples, process 100 is performed using only a client device or only multiple client devices. In process 100, some blocks are, optionally, combined, the order of some blocks is, optionally, changed, and some blocks are, optionally, omitted. In some examples, additional steps may be performed in combination with the process 100. Accordingly, the operations as illustrated (and described in greater detail below) are exemplary by nature and, as such, should not be viewed as limiting.

At block 102, an exemplary system (e.g., one or more electronic devices) may receive an audio signal. The audio signal may be obtained from any audio source and may include real audio and/or audio generated using one or more machine learning models (e.g., synthetically generated audio). The audio signal may be or include a raw audio waveform. The audio signal may form part of a file containing a plurality of audio signals. The audio signal may be a processed audio signal. The audio signal may include speech, non-speech, silence, or any combination thereof. The speech may include identifiable sentences, phrases, words, consonants, unstressed vowels, primary-stressed vowels, secondary-stressed vowels, voice onsets, voice offsets, or any combination thereof. The non-speech may include any noise other than human speech. The audio signal may be detected by an electronic acoustic sensor of the exemplary system. The audio signal may be detected by a sensor of a different system and transmitted to the system performing process 100 (e.g., via any wired or wireless electronic communications protocol). The audio signal may be obtained by the exemplary system from one or more electronic databases. The audio signal may be generated, at least in part, by one or more machine learning models.

At block 104, the exemplary system may extract a plurality of tokens corresponding to a plurality of features of the audio signal from each of a plurality of portions of the audio signal. One or more of the plurality of tokens may correspond to a respective temporal portion of the audio signal. One or more of the plurality of portions of the audio signal may form a discrete timestep of a waveform. For instance, each of the plurality of tokens may correspond to at least 0.1 seconds of the audio signal, at least 1.0 second of the audio signal, at least 10 seconds of the audio signal, and/or at least 1 minute of the audio signal. Each of the plurality of tokens may correspond to at most 0.1 seconds of the audio signal, at most 1.0 second of the audio signal, at most 10 seconds of the audio signal, and/or at most 1 minute of the audio signal. Processing tokens in the time domain may be advantageous in that it enables visualization of temporal regions of the audio comprising artifacts, such as synthetically generated audio (e.g., machine learning generated audio).

At block 106, the exemplary system may input the plurality of tokens into a deepfake detection machine learning model trained to predict whether the audio signal comprises synthetically generated audio. In some examples, the deepfake detection machine learning model may transform the plurality of tokens into embeddings. The deepfake detection machine learning model may generate an embedding representation based on each token. An embedding is a representation (e.g., vector representation) of the token that may capture rich semantic information about the token. The deepfake detection machine learning model may include a transformer model. The deepfake detection machine learning model may be an audio deepfake detection machine learning model, such as the Wav2Vec2-AASIST model described in H. Tak, M. Todisco, X. Wang, J.-w. Jung, J. Yamagishi, and N. Evans, “Automatic speaker verification spoofing and deepfake detection using wav2vec 2.0 and data augmentation,” in The Speaker and Language Recognition Workshop (Odyssey 2022), 2022, which is incorporated herein by reference in its entirety. However, it should be understood that the deepfake detection machine learning model may be any audio deepfake detection machine learning model.

At block 108, the exemplary system may generate, using the deepfake detection machine learning model, a plurality of output tokens. The plurality of output tokens may be generated based on the plurality of embeddings. One or more of the plurality of output tokens may include an indication of whether the audio signal comprises synthetically generated audio. The deepfake detection machine learning model may generate an attention map for one or more layers (e.g., layers of the transformer model). The output tokens and/or the attention map may be used to determine the contribution of different portions of the audio signal to a determination of whether the audio signal includes synthetically generated audio.

At block 110, the exemplary system may generate, using the deepfake detection machine learning model, a classification output indicating whether the audio signal comprises synthetically generated audio based on the plurality of output tokens. The deepfake detection machine learning model may include a classification head (e.g., a fully connected layer followed by softmax operation). The classification head may be trained to generate a classification output. In some examples, the exemplary system may generate a discrete (e.g., individual) classification output for each output token. In some examples, the classification output may include a binary output indicating whether the audio signal (or a portion thereof) includes synthetically generated audio. In some examples, the classification output includes a probability that the audio signal (or a portion thereof) includes synthetically generated audio.

At block 112, the exemplary system may determine a plurality of relevancy metrics associated with the plurality of output tokens for each portion of the audio signal. The plurality of relevancy metrics may be determined based on an attention map generated using the deepfake detection machine learning model. The relevancy metrics may form at least a portion of a relevancy map. The relevancy map may be iteratively computed as R∈R^{s×s}, where s is the number of tokens in the input audio signal. The relevancy metrics may be initialized with an identity matrix, indicating that the relevancy of the tokens is initially self-contained. Given a self-attention map Aᵢ after softmax operation for i-th layer in the machine learning model (e.g., transformer model), the relevancy metrics R, initialized with identity matrix, may be updated as:

$${R}_{upd} = {R}_{o l d} + {\overline{A}}_{i} \cdot {R}_{o l d} , {\overline{A}}_{i} = {E}_{h} \{ ( ∇ {A}_{i} ⊙ {A}_{i} ) + \} . \qquad ( 1 )$$

In (1), ⊙ is the Hadamard product, ∇Aᵢ is the gradient of Aᵢ with respect to the model output score corresponding to the class of interest (e.g., bona fide or deepfake), and Eₕ is an average over the heads in case of multi-head self-attention. In systems utilizing a [CLS] token, the row of R corresponding to the [CLS] token can be taken as the measure of relevancy for classifier decisions. However, transformer-based audio deepfake detection (ADD) models such as Wav2Vec2-AASIST, may not include a [CLS] token. To indicate the impact of a timestep in an audio signal waveform on an audio deepfake detection machine learning model outcome where no [CLS] token is included, the systems and methods disclosed herein may aggregate the relevance of the output tokens. The relevance of the output tokens may be aggregated using gradient weighted averaging, and the resulting method may be referred to herein as the Gradient Average Transformer Relevancy (GATR) method.

At block 114, the exemplary system may determine a weighting for each of the plurality of relevancy metrics. The weighting may be determined based on an attention map associated with the plurality of output tokens. The weighting may be determined based on an attention map of the final layer of the deepfake detection machine learning model (e.g., the final transformer layer). Determining the weighting may include averaging the rows of R across all tokens. Each row, t may be assigned a weight Wₜ, ∀t=1, . . . s, as

$${W}_{t} = {‖ {( {\hat{A}}_{W} )}_{t} ‖}_{2} , where , {\hat{A}}_{W} = Eh ( ∇ {A}_{N} ) . \qquad ( 2 )$$

In (2), A_{N} is the attention map for the final transformer layer and (Â_{W})ₜ is the t-th row of matrix Â_{W}. At block 116, the exemplary system may determine a contribution of each of the plurality of portions of the audio signal to the classification output based on a weighted relevancy of each portion. The contribution of each of the plurality of portions of the audio signal to the classification output may be determined as a relevancy vector, r, calculated as

$$r = ( {\sum }_{t = 1}^{s} {W}_{t} \cdot {R}_{t} ) / ( {\sum }_{t = 1}^{s} {W}_{t} ) . \qquad ( 3 )$$

The above relevancy vector, r, may be interpolated to match the length (e.g., number of time samples) of the input waveform T because Wav2Vec2 may compress the input waveform before feeding it to a transformer. The scores on the diagonal of R may be much higher than off it due to the initialization with an identity matrix. Thus, before taking the average, the identity matrix I∈R^{s×s} may be subtracted from R.

At block 118, the exemplary system may indicate the contribution of each of the plurality of portions of the audio signal to the classification output. In some examples, indicating the contribution of each of the plurality of portions of the audio signal to the classification output includes generating a visualization of the contribution of each of the plurality of portions of the audio signal to the classification output. In some examples, the visualization comprises a heatmap.

In some examples, the exemplary system performing process 100 may mask one or more portions of the audio signal based on the determined contribution of the of the plurality of portions of the audio signal to the classification output and train (e.g., retrain) the deepfake detection machine learning model based on the masked audio signal. In some examples, masking the one or more portions of the audio signal may include masking one or more portions determined to contribute by an above-threshold amount to the classification output. In some examples, masking the one or more portions of the audio signal comprises masking one or more portions determined to contribute by a below-threshold amount to the classification output. In some examples, masking the one or more portions of the audio signal comprises replacing the one or more portions with noise.

In some examples, the exemplary system performing process 100 may compare the determined contribution of the plurality of portions of the audio file to ground-truth labels associated with the audio file. The ground truth labels may indicate whether any one or more of the plurality of portions of the audio file comprise synthetically generated audio. The system may determine, based on the comparison, that a model performance threshold is not satisfied based on the comparison. The system may update the deepfake detection machine learning model in accordance with determining that the model performance threshold is not satisfied.

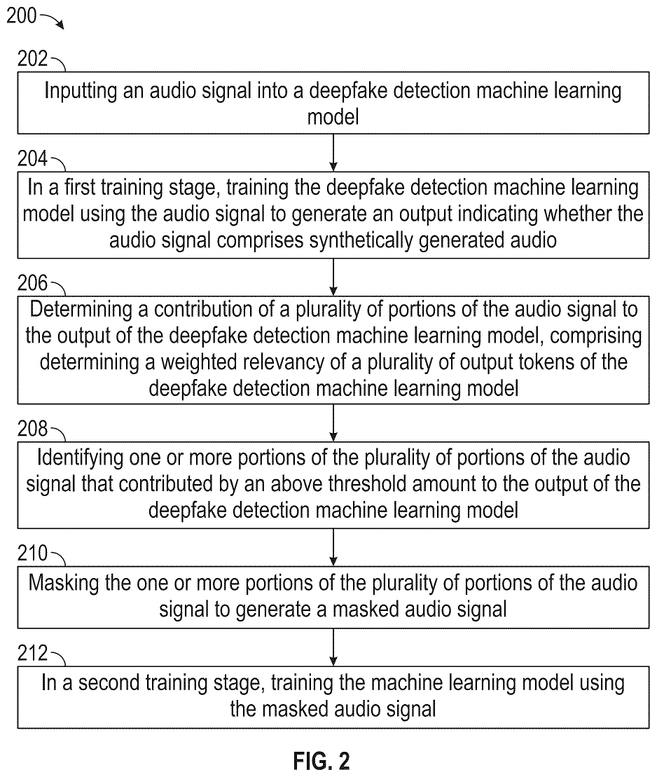

FIG. 2 illustrates aspects of an exemplary process 200 for training a deepfake detection machine learning model. Process 200 is performed, for example, using one or more electronic devices implementing a software platform. In some examples, process 200 is performed using a client-server system, and the blocks of process 200 are divided up in any manner between the server and a client device. In other examples, the blocks of process 200 are divided up between the server and multiple client devices. Thus, while portions of process 200 may be described herein as being performed by particular devices of a client-server system, it will be appreciated that process 200 is not so limited. In other examples, process 200 is performed using only a client device or only multiple client devices. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting.

At block 202, an exemplary system performing process 200 may input an audio signal into a deepfake detection machine learning model. The audio signal may be obtained from any audio source and may include real audio and/or audio generated using one or more machine learning models (e.g., synthetically generated audio). The audio signal may be or include a raw audio waveform. The audio signal may form part of a file containing a plurality of audio signals. The audio signal may be a processed audio signal.

The audio signal may include speech, non-speech, silence, or any combination thereof. The speech may include identifiable sentences, phrases, words, consonants, unstressed vowels, primary-stressed vowels, secondary-stressed vowels, voice onsets, voice offsets, or any combination thereof. The non-speech may include any noise other than human speech.

The audio signal may be detected by an electronic acoustic sensor of the exemplary system. The audio signal may be detected by a sensor of a different system and transmitted to the system performing process 100 (e.g., via any wired or wireless electronic communications protocol). The audio signal may be obtained by the exemplary system from one or more electronic databases. The audio signal may be generated, at least in part, by one or more machine learning models.

In some examples, inputting the audio signal into the deepfake detection machine learning model includes extracting a plurality of tokens corresponding to a plurality of features of the audio signal from each of the plurality of portions of the audio signal and inputting the plurality of tokens into the deepfake detection machine learning model trained to predict whether the audio signal comprises synthetically generated audio.

At block 204, the exemplary system may, in a first training stage, train the deepfake detection machine learning model using the audio signal to generate an output indicating whether the audio signal comprises synthetically generated audio. At block 206, the exemplary system may determine a contribution of a plurality of portions of the audio signal to the output of the deepfake detection machine learning model. Determining the contribution of the plurality of portions of the audio signal to the output of the deepfake detection machine learning model may include performing one or more steps of process 100 described above.

Determining the contribution of the plurality of portions of the audio signal to the output of the deepfake detection machine learning model may include determining a weighted relevancy of a plurality of output tokens of the deepfake detection machine learning model. In some examples, determining the contribution of the plurality of portions of the audio signal to the output of the deepfake detection machine learning model based on the weighted relevancy of a plurality of output tokens corresponding to the plurality of portions of the audio signal includes determining a plurality of relevancy scores associated with the plurality of output tokens for each portion of the audio signal; determining a weighting for each of the plurality of relevancy scores based on an attention map associated with the plurality of output tokens; and determining a contribution of each of the plurality of portions of the audio signal to the classification output based on a weighted relevancy of each portion.

At block 208, the exemplary system may identify one or more portions of the plurality of portions of the audio signal that contributed by an above threshold amount to the output of the deepfake detection machine learning model. At block 210, the exemplary system may mask the one or more identified portions of the plurality of portions of the audio signal to generate a masked audio signal. At block 212, the exemplary system may in a second training stage, train the machine learning model using the masked audio signal. In some examples, the deepfake detection machine learning model is trained to generate a plurality of output tokens, wherein one or more of the plurality of output tokens comprises an indication of whether the audio signal comprises synthetically generated audio. In some examples, the deepfake detection machine learning model is trained to generate a classification output indicating whether the audio signal comprises synthetically generated audio based on the plurality of output tokens.

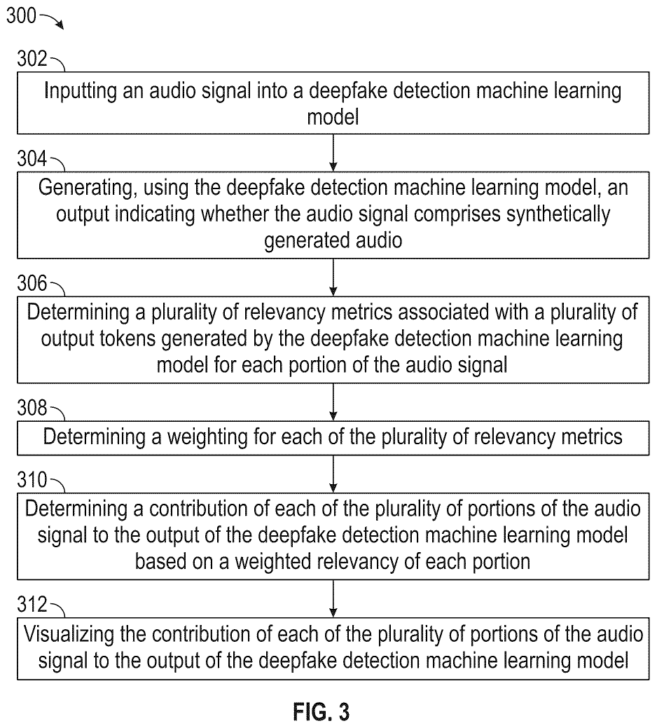

FIG. 3 illustrates another exemplary process 300 for detecting deepfake audio and indicating a contribution of different portions of the audio to the output. Process 300 is performed, for example, using one or more electronic devices implementing a software platform. In some examples, process 300 is performed using a client-server system, and the blocks of process 300 are divided up in any manner between the server and a client device. In other examples, the blocks of process 300 are divided up between the server and multiple client devices. Thus, while portions of process 300 may be described herein as being performed by particular devices of a client-server system, it will be appreciated that process 300 is not so limited. In other examples, process 300 is performed using only a client device or only multiple client devices. In process 300, some blocks are, optionally, combined, the order of some blocks is, optionally, changed, and some blocks are, optionally, omitted. In some examples, additional steps may be performed in combination with the process 300. Accordingly, the operations as illustrated (and described in greater detail below) are exemplary by nature and, as such, should not be viewed as limiting.

At block 302, an exemplary system (e.g., one or more electronic devices) may input an audio signal into a deepfake detection machine learning model. The audio signal may be obtained from any audio source and may include real audio and/or audio generated using one or more machine learning models (e.g., synthetically generated audio). The audio signal may be or include a raw audio waveform. The audio signal may form part of a file containing a plurality of audio signals. The audio signal may be a processed audio signal. The audio signal may include speech, non-speech, silence, or any combination thereof. The speech may include identifiable sentences, phrases, words, consonants, unstressed vowels, primary-stressed vowels, secondary-stressed vowels, voice onsets, voice offsets, or any combination thereof. The non-speech may include any noise other than human speech. The audio signal may be detected by an electronic acoustic sensor of the exemplary system. The audio signal may be detected by a sensor of a different system and transmitted to the system performing process 100 (e.g., via any wired or wireless electronic communications protocol). The audio signal may be obtained by the exemplary system from one or more electronic databases. The audio signal may be generated, at least in part, by one or more machine learning models.

The deepfake detection machine learning model may include a transformer model. The deepfake detection machine learning model may include, for instance, a deepfake detection machine learning model may be an audio deepfake detection machine learning model, such as the Wav2Vec2-AASIST model described in H. Tak, M. Todisco, X. Wang, J.-w. Jung, J. Yamagishi, and N. Evans, “Automatic speaker verification spoofing and deepfake detection using wav2vec 2.0 and data augmentation,” in The Speaker and Language Recognition Workshop (Odyssey 2022), 2022. The deepfake detection machine learning model may be configured to receive (and/or extract) a plurality of input tokens corresponding to a plurality of portions of the audio signal. The plurality of input tokens may correspond to a plurality of features of the audio signal from each of a plurality of portions of the audio signal.

At block 304, the exemplary system may generate, using the deepfake detection machine learning model, an output indicating whether the audio signal comprises synthetically generated audio. The deepfake detection machine learning model may generate a plurality of output tokens, wherein each of the plurality of output tokens comprises an indication of whether the audio signal comprises synthetically generated audio. One or more of the plurality of output tokens may include an indication of whether the audio signal comprises synthetically generated audio. The deepfake detection machine learning model may generate an attention map for one or more layers (e.g., layers of the transformer model). The output tokens and/or the attention map may be used to determine the contribution of different portions of the audio signal to a determination of whether the audio signal includes synthetically generated audio. The deepfake detection machine learning model may generate a classification output indicating whether the audio signal comprises synthetically generated audio based on the plurality of output tokens. The deepfake detection machine learning model may include a classification head (e.g., a fully connected layer followed by softmax operation). The classification head may be trained to generate a classification output. In some examples, the exemplary system may generate a discrete (e.g., individual) classification output for each output token. In some examples, the classification output may include a binary output indicating whether the audio signal (or a portion thereof) includes synthetically generated audio. In some examples, the classification output includes a probability that the audio signal (or a portion thereof) includes synthetically generated audio.

At block 306, the exemplary system may determine a plurality of relevancy metrics associated with a plurality of output tokens generated by the deepfake detection machine learning model for each portion of the audio signal. The plurality of relevancy metrics may be determined based on an attention map generated using the deepfake detection machine learning model. The relevancy metrics may form at least a portion of a relevancy map. The relevancy map may be iteratively computed as R∈R^{s×s}, where s is the number of tokens in the input audio signal. The relevancy metrics may be initialized with an identity matrix, indicating that the relevancy of the tokens is initially self-contained. Given a self-attention map Aᵢ after softmax operation for i-th layer in the machine learning model (e.g., transformer model), the relevancy metrics R, initialized with identity matrix, may be updated as:

$${R}_{upd} = {R}_{old} + {{A}^{-}}_{i} \cdot {R}_{old} , and {{A}^{-}}_{i} = {E}_{h} \{ ( ∇ {A}_{i} ⊙ {A}_{i} ) + \} . \qquad ( 1 )$$

In (1), ⊙ is the Hadamard product, ∇Aᵢ is the gradient of Aᵢ with respect to the model output score corresponding to the class of interest, and Eₕ is an average over the heads in case of multi-head self-attention. As discussed above, in systems utilizing a [CLS] token, the row of R corresponding to the [CLS] token can be taken as the measure of relevancy for classifier decisions. However, transformer-based audio deepfake detection (ADD) models such as Wav2Vec2-AASIST, may not include a [CLS] token. To indicate the impact of a timestep in an audio signal waveform on an audio deepfake detection machine learning model outcome where no [CLS] token is included, the systems and methods disclosed herein may aggregate the relevance of the output tokens, as discussed below with reference to blocks 308 and 310.

At block 308, the exemplary system may determine a weighting for each of the plurality of relevancy metrics. The weighting may be determined based on an attention map associated with the plurality of output tokens. The weighting may be determined based on an attention map of the final layer of the deepfake detection machine learning model (e.g., the final transformer layer). Determining the weighting may include averaging the rows of R across all tokens. Each row, t may be assigned a weight Wₜ, ∀t=1, . . . s, as

$${W}_{t} = {‖ {( {\hat{A}}_{W} )}_{t} ‖}_{2} , where , {\hat{A}}_{W} = Eh ( ∇ {A}_{N} ) . \qquad ( 2 )$$

In (2), A_{N} is the attention map for the final transformer layer and (A\hat{ }_{W})ₜ is the t-th row of matrix A\hat{ }_{W}.

At block 310, the exemplary system may determine a contribution of each of the plurality of portions of the audio signal to the output of the deepfake detection machine learning model based on a weighted relevancy of each portion. The contribution of each of the plurality of portions of the audio signal to the classification output may be determined as a relevancy vector, r, calculated as

$$r = ( {\sum }_{t = 1}^{s} {W}_{t} \cdot {R}_{t} ) / ( {\sum }_{t = 1}^{s} {W}_{t} ) . \qquad ( 3 )$$

The above relevancy vector, r, may be interpolated to match the length of the input waveform T because Wav2Vec2 may compress the input waveform before feeding it to a transformer. The scores on the diagonal of R may be much higher than off it due to the initialization with an identity matrix. Thus, before taking the average, the identity matrix I∈R^{s×s} may be subtracted from R.

At block 312, the exemplary system may visualize the contribution of each of the plurality of portions of the audio signal to the output of the deepfake detection machine learning model. In some examples, the visualization comprises a heatmap. The heatmap may indicate a contribution (e.g., absolute or relative) of each timestep of the audio signal to the output of the deepfake detection machine learning model.

In some examples, the exemplary system performing process 300 may mask one or more portions of the audio signal based on the determined contribution of the of the plurality of portions of the audio signal to the classification output and train (e.g., retrain) the deepfake detection machine learning model based on the masked audio signal. In some examples, masking the one or more portions of the audio signal may include masking one or more portions determined to contribute by an above-threshold amount to the classification output. In some examples, masking the one or more portions of the audio signal comprises masking one or more portions determined to contribute by a below-threshold amount to the classification output. In some examples, masking the one or more portions of the audio signal comprises replacing the one or more portions with noise. In some examples, the exemplary system performing process 300 may compare the determined contribution of the plurality of portions of the audio file to ground-truth labels associated with the audio file. The ground truth labels may indicate whether any one or more of the plurality of portions of the audio file comprise synthetically generated audio. The system may determine, based on the comparison, that a model performance threshold is not satisfied based on the comparison. The system may update the deepfake detection machine learning model in accordance with determining that the model performance threshold is not satisfied.

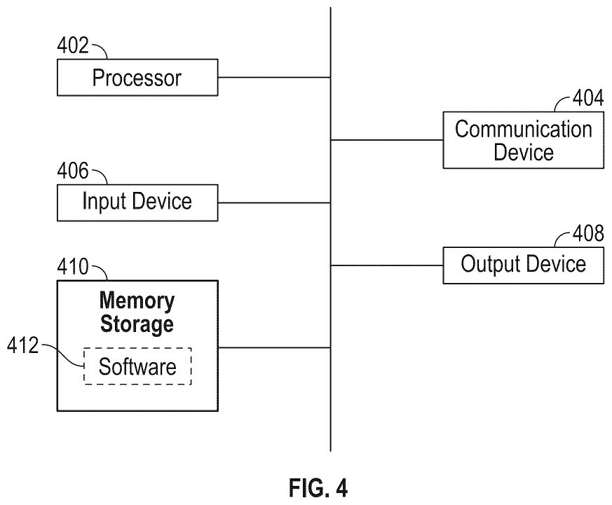

FIG. 4 depicts an exemplary computing device 400, in accordance with one or more examples of the disclosure. Device 400 can be a host computer connected to a network. Device 400 can be a client computer or a server. As shown in FIG. 4, device 400 can be any suitable type of microprocessor-based device, such as a personal computer, workstation, server, or handheld computing device (portable electronic device) such as a phone or tablet. The device can include, for example, one or more of processors 402, input device 406, output device 408, storage 410, and communication device 404. Input device 406 and output device 408 can generally correspond to those described above and can either be connectable or integrated with the computer.

Input device 406 can be any suitable device that provides input, such as a touch screen, keyboard or keypad, mouse, or voice-recognition device. Output device 408 can be any suitable device that provides output, such as a touch screen, haptics device, or speaker.

Storage 410 can be any suitable device that provides storage, such as an electrical, magnetic, or optical memory, including a RAM, cache, hard drive, or removable storage disk. Communication device 404 can include any suitable device capable of transmitting and receiving signals over a network, such as a network interface chip or device. The components of the computer can be connected in any suitable manner, such as via a physical bus or wirelessly.

Software 412, which can be stored in storage 410 and executed by processor 402, can include, for example, the programming that embodies the functionality of the present disclosure (e.g., as embodied in the devices as described above).

Software 412 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 410, that can contain or store programming for use by or in connection with an instruction execution system, apparatus, or device.

Software 412 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 400 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 400 can implement any operating system suitable for operating on the network. Software 412 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The systems and methods disclosed herein for providing enhanced explainability for AI models, referred to as the Gradient Average Transformer Relevancy (GATR) method have been shown to outperform various conventional explainable AI techniques, including Grad-CAM, GradientSHAP, and DeepSHAP. FIGS. 4-8 illustrate results of various performance analyses, including comparative analyses between GATR and the above convention methods.

### Comparison of Different Explainable AI (XAI) Methods

Faithfulness metrics: Common metrics to evaluate the faithfulness of heatmaps include Average Increase (AI ↑), Average Drop (AD ↓), Average Gain (AG ↑), and Input Fidelity (Fid-In ↑). In some examples, the peak-normalized heatmap from above XAI methods was used and multiply it with the input waveform to get a modified waveform. Then, Fid-In measures the change in predicted class between original and modified waveforms. The threshold corresponding to the equal error rate (EER) was used in some examples for model prediction. Similarly, AD measures the decrease in model confidence between original and modified waveforms, whereas AI and AG measure the increase in confidence.

Perturbation test: Both positive and negative perturbation tests were conducted. In the positive test, timesteps that correspond to the n % highest scores in the heatmap were noise-masked (replaced with noise). Then, the EER of the classifier was calculated on these masked utterances for n∈[10%, 90%]. In the negative test, the n % timesteps with the lowest scores were noise-masked. Masking was performed with Gaussian noise, having zero mean and same variance as the input waveform, instead of zero-mask to make the perturbed sample less out-of domain with respect to the original, knowing that Wav2Vec2-AASIST was trained with noise augmentations. For a good explanation, high (low) scores are expected to have high (low) impact on the classifier decision and, therefore, the EER should be high (low) after the positive (negative) perturbation. The area under curve (AUC) is reported herein for both tests.

Partial spoof test: Previous faithfulness metrics and perturbation test work with ground truth binary class label and do not evalaute the XAI methods in localizing the artifacts in the input audio. Partially spoofed audio that have both bona fide and spoof regions with corresponding labels was used and can serve as coarse ground-truth explanations. If an XAI method tracks the ground truth explanations well, it should give more importance to the spoof regions in the input audio when the classifier deems it as spoof. To evaluate this hypothesis, as well as a few others listed in the Experiments and Results section, below, the RCQ metric was used, detailed next.

### Automated Evaluation of Hypotheses

The Relative Contribution Quantification (RCQ) was used as a metric to conduct hypothesis testing at scale. RCQ was originally proposed in T. Liu, L. Zhang, R. K. Das, Y. Ma, R. Tao, and H. Li, “How Do Neural Spoofing Countermeasures Detect Partially Spoofed Audio?” in Interspeech 2024, 2024, pp. 1105-1109, to understand whether a classifier focused on speech or non-speech regions. Here, the metric is extended to any set of categories C relevant for evaluating a hypothesis. Given an utterance, category cᵢ∈C was considered for each timestep i∈{0, . . . , T}. Upon obtaining the heatmap scores sᵢ for each timestep i from a given XAI method, the scores S_{c} for each category c∈C can be calculated over a dataset of N utterances as

$${S}_{c} = \{ 1 / {\sum }_{𝔫 = 1}^{n = N} {\sum }_{i = 1}^{i = T} {{c}_{i} = c}_{} \} {\sum }_{n = 1}^{n = N} {\sum }_{i = 1}^{i = T} {s}_{i} \cdot {{c}_{i} = c}_{} .$$

The RCQ for category c is calculated as

$$R C {Q}_{c} = 100 \cdot ( {S}_{c} - {S}_{All} ) / {S}_{All} ,$$

where S_{All} is the average of scores over all considered utterances and all timesteps, ignoring the category. To investigate the model behaviour on spoof (or bona fide) audio, the spoof (or bona fide) subset of the dataset was used for S_{All} calculation. Before calculating RCQ, all heatmaps were normalized to [0,1] to ensure that different utterances have equal contribution to the final output. The higher the RCQ, the more important is the corresponding category, according to the XAI method.

For the partial spoof tests, the Relevance Rank Accuracy (RRA) and Relevance Mass Accuracy (RMA) metrics from L. Arras, A. Osman, and W. Samek, “CLEVR-XAI: A benchmark dataset for the ground truth evaluation of neural network explanations,” Information Fusion, vol. 81, pp. 14-40, 2022, were also calculated. The RRA measures how much of the high relevance scores lie within the ground truth region, whereas the RMA measures the ratio of high relevance scores assigned to the ground truth when compared to the entire utterance. The spoof regions were set as the ground truth.

### Experiments and Results

The pre-trained Wav2Vec2-AASIST model from the official opensource implementation described in H. Tak, M. Todisco, X. Wang, J.-w. Jung, J. Yamagishi, and N. Evans, “Automatic speaker verification spoofing and deepfake detection using wav2vec 2.0 and data augmentation,” in The Speaker and Language Recognition Workshop (Odyssey 2022), 2022, pp. 112-119, which is incorporated herein by reference in its entirety, was used. All the experiments were conducted on the logical access evaluation set of ASV19 dataset described in X. Wang, J. Yamagishi, M. Todisco, H. Delgado, A. Nautsch, N. Evans, M. Sahidullah, V. Vestman, T. Kinnunen, K. A. Lee et al., “ASVspoof 2019: A large-scale public database of synthesized, converted and replayed speech,” Computer Speech & Language, vol. 64, p. 101114, 2020, and In-The-Wild (ITW) dataset described in N. M. Mu\ddot{ } ller, P. Czempin, F. Dieckmann, A. Froghyar, and K. B\ddot{ } ottinger, “Does audio deepfake detection generalize?” Interspeech, 2022, on which the model achieves 0.2% and 10.8% equal error rate (EER), respectively. For the model, ASV19 is in-domain with relatively clean audio, whereas ITW is out-of-domain with more realistic acoustic conditions and newer spoofing methods. For the partial spoof test, the PartialSpoof dataset described in L. Zhang, X. Wang, E. Cooper, N. Evans, and J. Yamagishi, “The partialspoof database and countermeasures for the detection of short fake speech segments embedded in an utterance,” IEEE/ACM Transactions on Audio, Speech, and Language Processing, vol. 31, pp. 813-825, 2022 was used, which is based on ASV19 but has both bona fide and spoof regions within an utterance. The model achieves 6.6% EER on this dataset. Since the model is trained on peak-normalized inputs, the same normalization was used in all experiments.

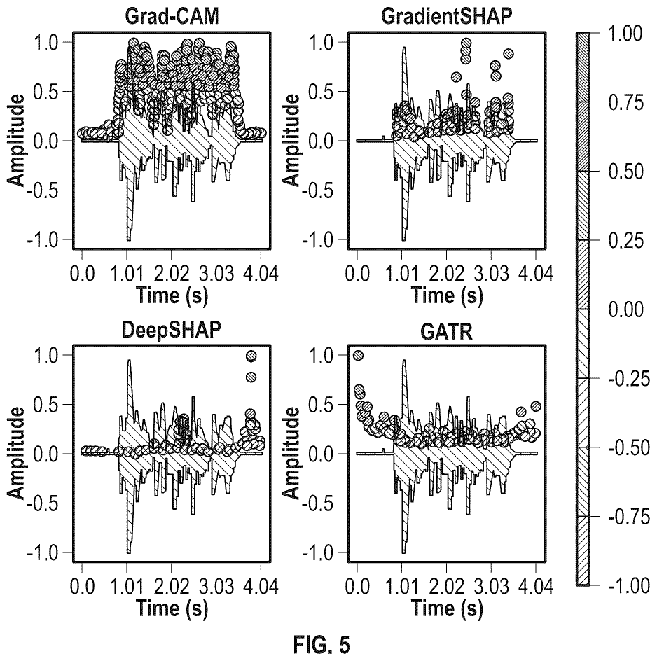

Disagreement of XAI methods: Existing works have shown that the ADD classifier may focus on either speech or non-speech regions. XAI can be used to verify this. FIG. 5 shows explanations from the four XAI methods for a sample utterance. For instance, FIG. 5 illustrates explanations from different explainable AI (XAI) methods for bona fide LA E 4965589 utterance from the ASV19 Dataset. The color intensity and circle height indicate the heatmap score.

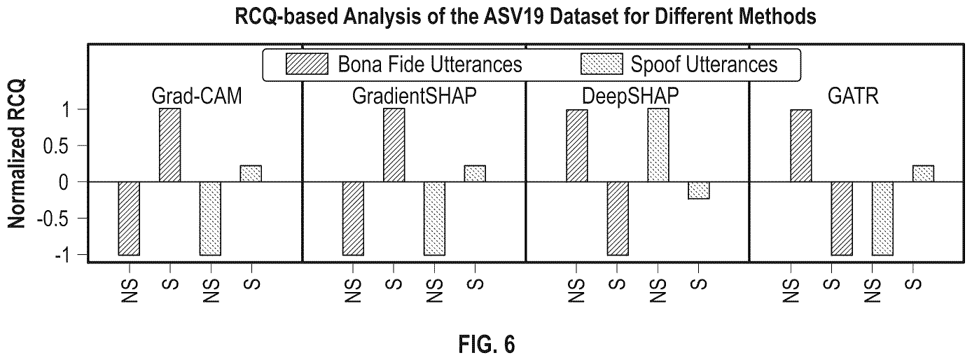

Unlike previous works, where only a handful of utterances were studied, the analysis presented herein shows that the difference holds at scale too, when tested on the dataset-level. The speech (S) and non-speech (NS) categories were obtained for each timestep in the utterances using WebRTC voice activity detector (VAD) and the RCQ values were calculated. The RCQs were normalized for each XAI method separately by dividing with the maximum RCQ magnitude across all the hypothesis categories. This does not affect the relative importance of categories but allows to plot RCQs for all the XAI methods together. FIG. 6 shows that the four XAI methods offer differing interpretations on the ASV19 dataset. Notably, the different methods provide opposite interpretations: DeepSHAP shows that the classifier focuses mainly on non-speech region whereas GradientSHAP highlights the speech region. This is in line with observations made on post-hoc XAI methods for some other classification tasks. Grad-CAM believes speech regions are more important for the decision-making on both bona fide and spoof utterances, whereas DeepSHAP assigns more importance to the non-speech regions.

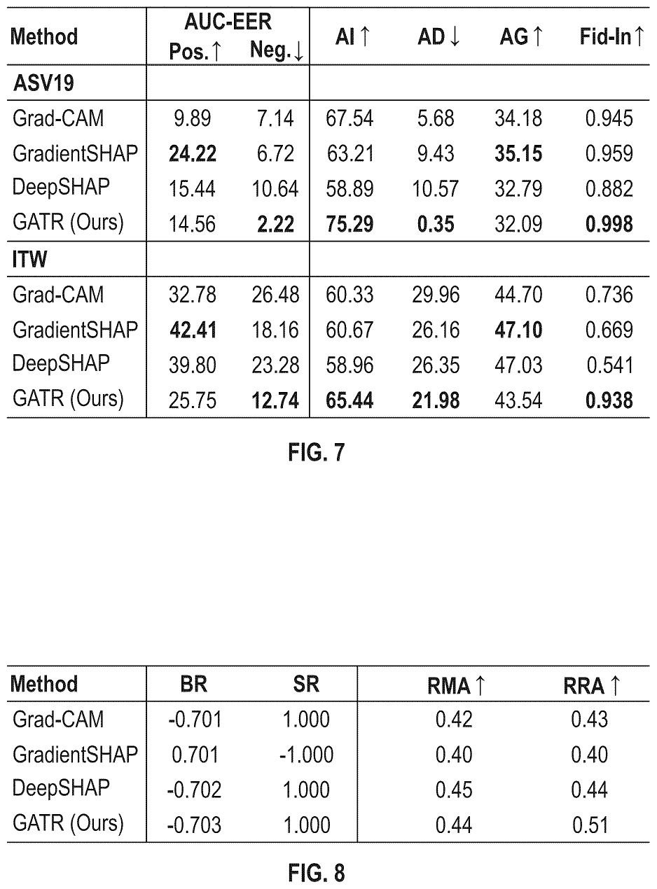

Comparison of the XAI methods: To better understand the real behavior of the classifier, the faithfulness of heatmaps from the different XAI methods was evaluated. The metrics from the Comparison of Different XAI Methods section were determined and are presented in FIGS. 7 and 8 for the ASV19/ITW and PartialSpoof datasets, respectively. In FIG. 7, Positive perturbation test is marked as Pos., and Negative is marked as Neg. From FIG. 7, the proposed GATR method disclosed herein is seen to perform better than the other XAI methods on most metrics. GradientSHAP achieves superior performance in terms of AUC in the positive perturbation test and AG, but it does not follow the coarse ground truth explanations for the partially spoofed audio in FIG. 8, which illustrates normalized relative contribution quantification (RCQs) for different categories, Relevance Mass Accuracy (RMA), and Relative Rank Accuracy (RRA) for different explainable AI methods on the PartialSpoof dataset according to some examples. Bona fide regions category is indicated as BR, spoof regions are indicated as SR. In fact, from FIG. 8, all methods except GradientSHAP are able to assign high importance to the spoof regions when the classifier deems an utterance as spoof.

Automatic evaluation of hypotheses: Two common hypotheses from the ADD literature are the relative importance of speech compared to non-speech regions and importance of vowels compared to consonants in the speech regions. The role of silence was also explored in Y. Zhang, Z. Li, J. Lu, H. Hua, W. Wang, and P. Zhang, “The impact of silence on speech anti-spoofing,” IEEE/ACM Transactions on Audio, Speech, and Language Processing, 2023 and N. M. Mu\ddot{ } ller, F. Dieckmann, P. Czempin, R. Canals, K. B\ddot{ } ottinger, and J. Williams, “Speech is Silver, Silence is Golden: What do ASVspooftrained Models Really Learn?” in 2021 Edition of the Automatic Speaker Verification and Spoofing Countermeasures Challenge, 2021, pp. 55-60. The role of vowels was investigated in W. Ge, M. Todisco, and N. Evans, “Explainable Deepfake and Spoofing Detection: An Attack Analysis Using SHapley Additive explanations,” in Proc. The Speaker and Language Recognition Workshop (Odyssey 2022), 2022, pp. 70-76 by manually analyzing a limited number of utterances, which may not hold for a larger dataset. These hypotheses were evaluated for an entire dataset by applying RCQ on the GATR explanations.

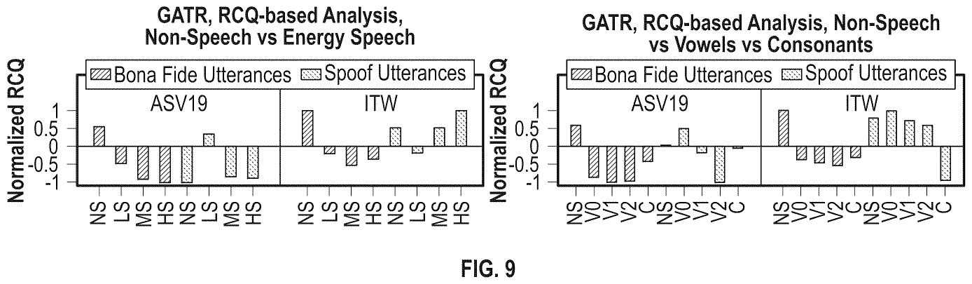

Speech vs Non-Speech: The WebRTC VAD was used to obtain speech and non-speech regions. The speech region was further divide dinto low-energy (LS), middle-energy (MS), and high-energy (HS) categories to also study the importance of voice onset and offset regions, following W. Ge, M. Todisco, and N. Evans, “Explainable Deepfake and Spoofing Detection: An Attack Analysis Using SHapley Additive explanations,” in Proc. The Speaker and Language Recognition Workshop (Odyssey 2022), 2022, pp. 70-76, which is incorporated herein by reference in its entirety. The boundaries were obtained by linearly dividing amplitude range [0,1] in the log-scale into three intervals (low, middle, and high), as was done in FastSpeech2: Y. Ren, C. Hu, X. Tan, T. Qin, S. Zhao, Z. Zhao, and T.-Y. Liu, “FastSpeech 2: Fast and High-Quality End-to-End Text to Speech,” in International Conference on Learning Representations, 2021. The normalized RCQs for these categories are presented in the left part of the FIG. 9, which illustrates normalized RCQ scores for different categories calculated on Gradient Average Transformer Relevancy (GATR) heatmaps according to some examples. The datasets are divided by the vertical lines. Larger normalized RCQ values indicate higher importance of the corresponding category according to GATR. Category names include: S: speech, NS: non-speech, V0: unstressed vowel, V1: primary stressed vowel, V2: secondary stressed vowel, C: consonants, LS: low-energy speech, MS: middle-energy speech and HS: high-energy speech. A score of −1 (or 1) means that the GATR explanation assigns the lowest (or highest) importance. A similar trend was found for bona fide utterances in both ASV19 and ITW datasets. Non-speech (NS) regions are the most important among all regions and voice onset region (LS) has higher importance among the low, middle and high energy speech regions. However, for spoofed utterances, a conflicting trend was identified for the two datasets. Voice onset (LS) seems to be the most important with non-speech (NS) being the least for ASV19. However, LS has the lowest importance for ITW dataset with high energy (HS) regions being the most important.

Vowels vs Consonants: In W. Ge, M. Todisco, and N. Evans, “Explainable Deepfake and Spoofing Detection: An Attack Analysis Using SHapley Additive explanations,” in Proc. The Speaker and Language Recognition Workshop (Odyssey 2022), 2022, pp. 70-76, the authors found that the artifacts may lie in dominant vowels regions. To verify this hypothesis at scale, the importance of consonants (C), unstressed vowels (V0), primary-stressed vowels (V1), secondary-stressed vowels (V2), and non-speech (NS) were compared. To compute RCQ scores, the text transcription for each utterance was obtained using NVIDIA Canary-1b automatic speech recognition system and then Montreal Forced Aligner was used to get phoneme-level alignment of the transcription and speech. From FIG. 9 (right), it is apparent that for the spoof class, the unstressed vowel (V0) is the most important, while consonant regions are the second most important speech regions on the ASV19 dataset. However, for the ITW dataset, all the vowel categories are about equally important with consonant being the least important. The bonafide utterances were skipped since non-speech is the most important region for both datasets.

### CLAUSES

Clause 1. A method for detecting deepfake audio that indicates a contribution of different portions of the audio to an output, the method comprising: receiving an audio signal; extracting a plurality of tokens corresponding to a plurality of features of the audio signal from each of a plurality of portions of the audio signal; inputting the plurality of tokens into a deepfake detection machine learning model trained to predict whether the audio signal comprises synthetically generated audio; generating, using the deepfake detection machine learning model, a plurality of output tokens, wherein each of the plurality of output tokens comprises an indication of whether the audio signal comprises synthetically generated audio; generating, using the deepfake detection machine learning model, a classification output indicating whether the audio signal comprises synthetically generated audio based on the plurality of output tokens; determining a plurality of relevancy metrics associated with the plurality of output tokens for each portion of the audio signal; determining a weighting for each of the plurality of relevancy metrics; determining a contribution of each of the plurality of portions of the audio signal to the classification output based on a weighted relevancy of each portion; and indicating the contribution of each of the plurality of portions of the audio signal to the classification output.

Clause 2. The method of clause 1, comprising: masking one or more portions of the audio signal based on the determined contribution of the of the plurality of portions of the audio signal to the classification output; and training the deepfake detection machine learning model based on the masked audio signal.

Clause 3. The method of clause 2, wherein masking the one or more portions of the audio signal comprises masking one or more portions determined to contribute by an above-threshold amount to the classification output.

Clause 4. The method of clause 2, wherein masking the one or more portions of the audio signal comprises masking one or more portions determined to contribute by a below-threshold amount to the classification output.

Clause 5. The method of any one of clauses 2-4, wherein masking the one or more portions of the audio signal comprises replacing the one or more portions with noise.

Clause 6. The method of any one of clauses 1-5, wherein the weighting for each of the plurality of relevancy metrics is determined based on an attention map associated with the plurality of output tokens.

Clause 7. The method of any one of clauses 1-6, comprising: comparing the determined contribution of the plurality of portions of the audio signal to ground-truth labels associated with the audio signal, wherein the ground truth labels indicate whether the plurality of portions of the audio signal comprise synthetically generated audio; determining that a model performance threshold is not satisfied based on the comparison; and updating the deepfake detection machine learning model.

Clause 8. The method of any one of clauses 1-7, wherein indicating the contribution of each of the plurality of portions of the audio signal to the classification output includes generating a visualization of the contribution of each of the plurality of portions of the audio signal to the classification output, wherein the visualization comprises a heatmap.

Clause 9. The method of any one of clauses 1-8, wherein the weighted relevancy of each portion of the audio signal comprises a vector representation of a relevancy of each portion of the audio signal.

Clause 10. The method of any one of clauses 1-9, wherein each of the plurality of portions of the audio signal forms a timestep of a waveform.

Clause 11. The method of any one of clauses 1-10, wherein one or more of the plurality of input tokens correspond to speech data, non-speech data, or a combination thereof.

Clause 12. The method of any one of clauses 1-11, wherein the deepfake detection machine learning model comprises a transformer model.

Clause 13. The method of any one of clauses 1-12, wherein determining the plurality of relevancy metrics comprises: initializing a relevancy matrix as an identity matrix; and for each of a plurality of transformer layers of the deepfake detection machine learning model, updating the relevancy matrix based on a self-attention map for the corresponding transformer layer of the plurality of transformer layers.

Clause 14. The method of clause 13, wherein updating the relevancy matrix comprises, for each transformer layer: obtaining a self-attention map; computing a gradient of the self-attention map based on the classification output; computing a gradient-weighted self-attention map by taking a Hadamard product between the gradient and the self-attention map and averaging over one or more attention heads of the deepfake detection machine learning model; and updating the relevancy matrix based on the gradient-weighted self-attention map.

Clause 15. The method of any one of clauses 13-14, comprising subtracting the identity matrix from the relevancy matrix before determining the weighting for each of the plurality of relevancy metrics.

Clause 16. The method of any one of clauses 1-15, wherein determining the weighting for each of the plurality of relevancy metrics comprises: obtaining an attention map for a final transformer layer of the deepfake detection machine learning model; computing a gradient of the attention map with respect to the classification output; averaging the gradient over attention heads of the deepfake detection machine learning model to form a gradient matrix; and computing, for each of the plurality of output tokens, a respective weight based on the gradient matrix.

Clause 17. The method of clause 16, wherein determining the contribution of each of the plurality of portions of the audio signal comprises computing a weighted average of rows of a relevancy matrix using the weights to obtain a relevancy vector.

Clause 18. The method of clause 17, further comprising interpolating the relevancy vector to match a length of the audio signal, wherein the contribution indicated for each of the plurality of portions of the audio signal is determined from the interpolated relevancy vector.

Clause 19. A system for detecting deepfake audio that indicates a contribution of different portions of the audio to an output, the system comprising one or more processors, a memory, and one or more programs, wherein the one or more programs are stored in the memory and configured to be executed by the one or more processors, the one or more programs including instructions for: receiving an audio signal; extracting a plurality of tokens corresponding to a plurality of features of the audio signal from each of a plurality of portions of the audio signal; inputting the plurality of tokens into a deepfake detection machine learning model trained to predict whether the audio signal comprises synthetically generated audio; generating, using the deepfake detection machine learning model, a plurality of output tokens, wherein each of the plurality of output tokens comprises an indication of whether the audio signal comprises synthetically generated audio; generating, using the deepfake detection machine learning model, a classification output indicating whether the audio signal comprises synthetically generated audio based on the plurality of output tokens; determining a plurality of relevancy metrics associated with the plurality of output tokens for each portion of the audio signal; determining a weighting for each of the plurality of relevancy metrics; determining a contribution of each of the plurality of portions of the audio signal to the classification output based on a weighted relevancy of each portion; and indicating the contribution of each of the plurality of portions of the audio signal to the classification output.

Clause 20. A non-transitory computer-readable storage medium storing one or more programs for detecting deepfake audio and indicating a contribution of different portions of the audio to an output, the one or more programs comprising instructions, which when executed by one or more processors of an electronic device, cause the electronic device to: receive an audio signal; extract a plurality of tokens corresponding to a plurality of features of the audio signal from each of a plurality of portions of the audio signal; input the plurality of tokens into a deepfake detection machine learning model trained to predict whether the audio signal comprises synthetically generated audio; generate, using the deepfake detection machine learning model, a plurality of output tokens, wherein each of the plurality of output tokens comprises an indication of whether the audio signal comprises synthetically generated audio; generate, using the deepfake detection machine learning model, a classification output indicating whether the audio signal comprises synthetically generated audio based on the plurality of output tokens; determine a plurality of relevancy metrics associated with the plurality of output tokens for each portion of the audio signal; determine a weighting for each of the plurality of relevancy metrics; determine a contribution of each of the plurality of portions of the audio signal to the classification output based on a weighted relevancy of each portion; and indicate the contribution of each of the plurality of portions of the audio signal to the classification output.

Clause 21. A method for training a deepfake detection machine learning model, the method comprising: inputting an audio signal into the deepfake detection machine learning model; in a first training stage, training the deepfake detection machine learning model using the audio signal to generate an output indicating whether the audio signal comprises synthetically generated audio; determining a contribution of a plurality of portions of the audio signal to the output of the deepfake detection machine learning model, comprising determining a weighted relevancy of a plurality of output tokens of the deepfake detection machine learning model; identifying one or more portions of the plurality of portions of the audio signal that contributed by an above threshold amount to the output of the deepfake detection machine learning model; masking the one or more portions of the plurality of portions of the audio signal to generate a masked audio signal; and in a second training stage, training the machine learning model using the masked audio signal.

Clause 22. The method of clause 21, wherein inputting the audio signal into the deepfake detection machine learning model comprises: extracting a plurality of tokens corresponding to a plurality of features of the audio signal from each of the plurality of portions of the audio signal; and inputting the plurality of tokens into the deepfake detection machine learning model trained to predict whether the audio signal comprises synthetically generated audio.

Clause 23. The method of any one of clauses 21-22, wherein the deepfake detection machine learning model is trained to: generate a plurality of output tokens, wherein each of the plurality of output tokens comprises an indication of whether the audio signal comprises synthetically generated audio; and generate a classification output indicating whether the audio signal comprises synthetically generated audio based on the plurality of output tokens.

Clause 24. The method of any one of clauses 21-23, wherein determining the contribution of the plurality of portions of the audio signal to the output of the deepfake detection machine learning model based on the weighted relevancy of a plurality of output tokens corresponding to the plurality of portions of the audio signal comprises: determining a plurality of relevancy scores associated with the plurality of output tokens for each portion of the audio signal; determining a weighting for each of the plurality of relevancy scores based on an attention map associated with the plurality of output tokens; and determining a contribution of each of the plurality of portions of the audio signal to the classification output based on a weighted relevancy of each portion.

Clause 25. A system for training a deepfake detection machine learning model, the system comprising one or more processors, a memory, and one or more programs, wherein the one or more programs are stored in the memory and configured to be executed by the one or more processors, the one or more programs including instructions for: inputting an audio signal into the deepfake detection machine learning model; in a first training stage, training the deepfake detection machine learning model using the audio signal to generate an output indicating whether the audio signal comprises synthetically generated audio; determining a contribution of a plurality of portions of the audio signal to the output of the deepfake detection machine learning model, comprising determining a weighted relevancy of a plurality of output tokens of the deepfake detection machine learning model; identifying one or more portions of the plurality of portions of the audio signal that contributed by an above threshold amount to the output of the deepfake detection machine learning model; masking the one or more portions of the plurality of portions of the audio signal to generate a masked audio signal; and in a second training stage, training the machine learning model using the masked audio signal.

Clause 26. A non-transitory computer-readable storage medium storing one or more programs for training a deepfake detection machine learning model, the one or more programs comprising instructions, which when executed by one or more processors of an electronic device, cause the electronic device to: input an audio signal into the deepfake detection machine learning model; in a first training stage, train the deepfake detection machine learning model using the audio signal to generate an output indicating whether the audio signal comprises synthetically generated audio; determine a contribution of a plurality of portions of the audio signal to the output of the deepfake detection machine learning model, comprising determining a weighted relevancy of a plurality of output tokens of the deepfake detection machine learning model; identify one or more portions of the plurality of portions of the audio signal that contributed by an above threshold amount to the output of the deepfake detection machine learning model; mask the one or more portions of the plurality of portions of the audio signal to generate a masked audio signal; and in a second training stage, train the machine learning model using the masked audio signal.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for detecting deepfake audio that indicates a contribution of different portions of the audio to an output, the method comprising:
receiving an audio signal;
extracting a plurality of tokens corresponding to a plurality of features of the audio signal from each of a plurality of portions of the audio signal;
inputting the plurality of tokens into a deepfake detection machine learning model trained to predict whether the audio signal comprises synthetically generated audio;
generating, using the deepfake detection machine learning model, a plurality of output tokens, wherein each of the plurality of output tokens comprises an indication of whether the audio signal comprises synthetically generated audio;
generating, using the deepfake detection machine learning model, a classification output indicating whether the audio signal comprises synthetically generated audio based on the plurality of output tokens;
determining a plurality of relevancy metrics associated with the plurality of output tokens for each portion of the audio signal;
determining a weighting for each of the plurality of relevancy metrics;
determining a contribution of each of the plurality of portions of the audio signal to the classification output based on a weighted relevancy of each portion; and
indicating the contribution of each of the plurality of portions of the audio signal to the classification output.

2. The method of claim 1, comprising:
masking one or more portions of the audio signal based on the determined contribution of the of the plurality of portions of the audio signal to the classification output; and
training the deepfake detection machine learning model based on the masked audio signal.

3. The method of claim 2, wherein masking the one or more portions of the audio signal comprises masking one or more portions determined to contribute by an above-threshold amount to the classification output.

4. The method of claim 2, wherein masking the one or more portions of the audio signal comprises masking one or more portions determined to contribute by a below-threshold amount to the classification output.

5. The method of claim 2, wherein masking the one or more portions of the audio signal comprises replacing the one or more portions with noise.

6. The method of claim 1, wherein the weighting for each of the plurality of relevancy metrics is determined based on an attention map associated with the plurality of output tokens.

7. The method of claim 1, comprising:
comparing the determined contribution of the plurality of portions of the audio signal to ground-truth labels associated with the audio signal, wherein the ground truth labels indicate whether the plurality of portions of the audio signal comprise synthetically generated audio;
determining that a model performance threshold is not satisfied based on the comparison; and
updating the deepfake detection machine learning model.

8. The method of claim 1, wherein indicating the contribution of each of the plurality of portions of the audio signal to the classification output includes generating a visualization of the contribution of each of the plurality of portions of the audio signal to the classification output, wherein the visualization comprises a heatmap.

9. The method of claim 1, wherein the weighted relevancy of each portion of the audio signal comprises a vector representation of a relevancy of each portion of the audio signal.

10. The method of claim 1, wherein each of the plurality of portions of the audio signal forms a timestep of a waveform.

11. The method of claim 1, wherein one or more of the plurality of input tokens correspond to speech data, non-speech data, or a combination thereof.

12. The method of claim 1, wherein the deepfake detection machine learning model comprises a transformer model.

13. The method of claim 1, wherein determining the plurality of relevancy metrics comprises:
initializing a relevancy matrix as an identity matrix; and
for each of a plurality of transformer layers of the deepfake detection machine learning model, updating the relevancy matrix based on a self-attention map for the corresponding transformer layer of the plurality of transformer layers.

14. The method of claim 13, wherein updating the relevancy matrix comprises, for each transformer layer:
obtaining a self-attention map;
computing a gradient of the self-attention map based on the classification output;
computing a gradient-weighted self-attention map by taking a Hadamard product between the gradient and the self-attention map and averaging over one or more attention heads of the deepfake detection machine learning model; and
updating the relevancy matrix based on the gradient-weighted self-attention map.

15. The method of claim 13, comprising subtracting the identity matrix from the relevancy matrix before determining the weighting for each of the plurality of relevancy metrics.

16. The method of claim 1, wherein determining the weighting for each of the plurality of relevancy metrics comprises:
obtaining an attention map for a final transformer layer of the deepfake detection machine learning model;
computing a gradient of the attention map with respect to the classification output;
averaging the gradient over attention heads of the deepfake detection machine learning model to form a gradient matrix; and
computing, for each of the plurality of output tokens, a respective weight based on the gradient matrix.

17. The method of claim 16, wherein determining the contribution of each of the plurality of portions of the audio signal comprises computing a weighted average of rows of a relevancy matrix using the weights to obtain a relevancy vector.

18. The method of claim 17, further comprising interpolating the relevancy vector to match a length of the audio signal, wherein the contribution indicated for each of the plurality of portions of the audio signal is determined from the interpolated relevancy vector.

19. A system for detecting deepfake audio that indicates a contribution of different portions of the audio to an output, the system comprising one or more processors, a memory, and one or more programs, wherein the one or more programs are stored in the memory and configured to be executed by the one or more processors, the one or more programs including instructions for:
receiving an audio signal;
extracting a plurality of tokens corresponding to a plurality of features of the audio signal from each of a plurality of portions of the audio signal;
inputting the plurality of tokens into a deepfake detection machine learning model trained to predict whether the audio signal comprises synthetically generated audio;
generating, using the deepfake detection machine learning model, a plurality of output tokens, wherein each of the plurality of output tokens comprises an indication of whether the audio signal comprises synthetically generated audio;
generating, using the deepfake detection machine learning model, a classification output indicating whether the audio signal comprises synthetically generated audio based on the plurality of output tokens;
determining a plurality of relevancy metrics associated with the plurality of output tokens for each portion of the audio signal;
determining a weighting for each of the plurality of relevancy metrics;
determining a contribution of each of the plurality of portions of the audio signal to the classification output based on a weighted relevancy of each portion; and
indicating the contribution of each of the plurality of portions of the audio signal to the classification output.

20. A non-transitory computer-readable storage medium storing one or more programs for detecting deepfake audio and indicating a contribution of different portions of the audio to an output, the one or more programs comprising instructions, which when executed by one or more processors of an electronic device, cause the electronic device to:
receive an audio signal;
extract a plurality of tokens corresponding to a plurality of features of the audio signal from each of a plurality of portions of the audio signal;
input the plurality of tokens into a deepfake detection machine learning model trained to predict whether the audio signal comprises synthetically generated audio;
generate, using the deepfake detection machine learning model, a plurality of output tokens, wherein each of the plurality of output tokens comprises an indication of whether the audio signal comprises synthetically generated audio;
generate, using the deepfake detection machine learning model, a classification output indicating whether the audio signal comprises synthetically generated audio based on the plurality of output tokens;
determine a plurality of relevancy metrics associated with the plurality of output tokens for each portion of the audio signal;
determine a weighting for each of the plurality of relevancy metrics;
determine a contribution of each of the plurality of portions of the audio signal to the classification output based on a weighted relevancy of each portion; and
indicate the contribution of each of the plurality of portions of the audio signal to the classification output.
